(19) United States
(12) Patent Application Publication
(10) Pub. No.: US 2014/0069578 A1
(43) Pub. Date: Mar. 13, 2014

(54) SHAPE MEMORY POLYMER WHICH FUNCTIONS AS A REVERSIBLE DRY ADHESIVE AND METHODS OF MAKING AND USING THE SAME

(71) Applicants: Tao Xie, Troy, MI (US); Nilesh D. Mankame, Ann Arbor, MI (US)

(72) Inventors: Tao Xie, Troy, MI (US); Nilesh D. Mankame, Ann Arbor, MI (US)

(73) Assignee: GM GLOBAL TECHNOLOGY OPERATIONS LLC, Detroit, MI (US)

(21) Appl. No.: 13/613,462

(22) Filed: Sep. 13, 2012

(51) Int. Cl. C09J 7/00; B32B 37/12; B32B 38/10; C09J 163/00

(52) U.S. Cl. 156/247; 525/523; 428/174; 156/327

(57) ABSTRACT

One embodiment of the invention includes a shape memory polymer which functions similar to a gecko footpad. A shape memory polymer may exhibit adhesive properties when heated above its glass transition temperature. A shape memory polymer may function as a reversible dry adhesive.

### FIELD OF THE INVENTION

The field to which the disclosure generally relates includes compositions of shape memory polymers which function as dry adhesives.

### BACKGROUND

Gecko feet pads, with nanohair structures on them, are examples of smart dry adhesives. The working principle of the Gecko adhesion is that the nanohair structure allows the foot pad to make maximum contact with a counter surface regardless of its roughness and chemical composition. This is accomplished by nanohairs that are relatively long and protruding from the foot pad at an angle so that adjacent nanohairs can contact the counter surface regardless of its topography. The maximum contact further allows for accumulation of millions of small van der Waals (in the range of microNewtons) interactions between the Gecko foot pad and the counter surface, leading to an overall adhesion force (pull-off force) of about 10 N/cm². When the detaching force is employed in a peel-off mode, however, the complete detachment is achieved gradually by overcoming small adhesion forces corresponding to very small areas. Thus, the adhesion is easily reversed. Overall, the attractiveness of the Gecko adhesion lies in the combination of adhesive strength (10 N/cm²), reversibility, and the ability to adapt to a variety of surfaces in terms of both the surface roughness and composition. The above unique features of the Gecko adhesion has stimulated scientific research efforts to produce synthetic smart dry adhesives that work using the same principle as the Gecko feet. Up to now, the two best synthetic Gecko adhesives show maximum pull-off adhesive strength of 3 and 10 N/cm² towards glass. Both adhesives suffer from severe adhesion loss after only one or two attaching/detaching cycles, as a result of breakdown and the lateral collapse of the nano structures, with the latter referring to the adjacent nano hairs of the Gecko foot pad bonding to each other. In addition, synthetic Gecko adhesives are expensive to produce and large-scale manufacturing is practically too difficult.

In some instances, shape memory polymers may exhibit material properties similar to traditional dry adhesives when heated. These shape memory polymers may exhibit desired characteristics similar to the adhesive strength, reversibility, and the ability to adapt to a variety of surfaces in terms of both the surface roughness and composition similar to that of Gecko adhesives.

### SUMMARY OF EXEMPLARY EMBODIMENTS OF THE INVENTION

One embodiment of the invention includes a shape memory polymer which functions as a dry adhesive.

Another embodiment of the invention includes a product comprising a shape memory polymer which functions as a dry adhesive with a pull-off strength of up to 2000 N/cm² from a substrate.

One embodiment of the invention includes a reversible shape memory polymer composition comprising an aliphatic diepoxy and a diamine curing agent.

One embodiment may provide an attachment pad including a shape memory polymer which functions as a reversible dry adhesive including a shape memory polymer layer; the shape memory polymer which functions as a dry adhesive having a curved surface when the shape memory polymer layer is below its glass transition temperature and unaffected by a load; and a means for evenly applying a load on the perimeter of the shape memory polymer which functions as a reversible dry adhesive including, but not limited to, a spring.

One embodiment may provide a single layer shape memory polymer which functions as a reversible dry adhesive including a shape memory polymer layer; the reversible shape memory polymer layer having a curved surface when the shape memory polymer layer is below its glass transition temperature and unaffected by a load; and a means for evenly applying a load on the perimeter of the reversible shape memory polymer which functions as a dry adhesive including, but not limited to, a spring.

Another embodiment of the invention may include a method comprising providing a shape memory polymer which functions as a reversible dry adhesive, placing the adhesive on a surface, preloading the adhesive with the force so that the adhesive has a pull-off strength greater than 100 N/cm² from a substrate, and a peel-off force of 1 N/cm² or less from the same substrate.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 illustrates the chemical structures of Jeffamine D-230, EPON 826, and an octadecyl amine.

FIG. 2 illustrates a pull-off force on a rigid backing of a shape memory polymer which functions as a dry adhesive.

FIG. 3 illustrates a method of a shape memory polymer which functions as a reversible dry adhesive being adhered and subsequently removed from a substrate through a peel-off method.

FIG. 4 illustrates a method of a shape memory polymer which functions as a reversible dry adhesive having a curved structure being adhered and subsequently removed from a substrate through a peel-off method.

### DETAILED DESCRIPTION OF EXEMPLARY EMBODIMENTS

The following description of the embodiment(s) is merely exemplary in nature and is in no way intended to limit the invention, its application, or uses.

One embodiment of the invention may include a shape memory polymer which may function similar to a gecko footpad. A shape memory polymer may exhibit adhesive properties when heated above its glass transition temperature. A shape memory polymer may have a rigid structure when cooled below its glass transition temperature. These shape memory polymers may function as reversible dry adhesives.

In one embodiment, the shape memory polymer may have a glass transition temperature T_{g} ranging from 30 to 200° C.

One embodiment of the invention may include a shape memory polymer which functions as a dry adhesive which may be comprised of a rigid epoxy or a flexible epoxy and a crosslinking agent or a catalytic curing agent sufficient to form a reversible shape memory polymer which functions as a dry adhesive which exhibits adhesive properties when heated above its glass transition temperature.

In one embodiment, the shape memory polymer layer may be made as follows. A first step may include mixing EPON 826 with Jeffamin D-230 and decylamine at a mole ratio of 20:0.5:19. A second step may include pouring the mixture into a mold and curing the mixture in an oven at 100° C. for one hour. A third step may include additionally curing the mixture in an oven at 130° C. for one hour. EPON 826 and Jeffamine D-230 may be obtained from Hexion and Huntsman, respectively.

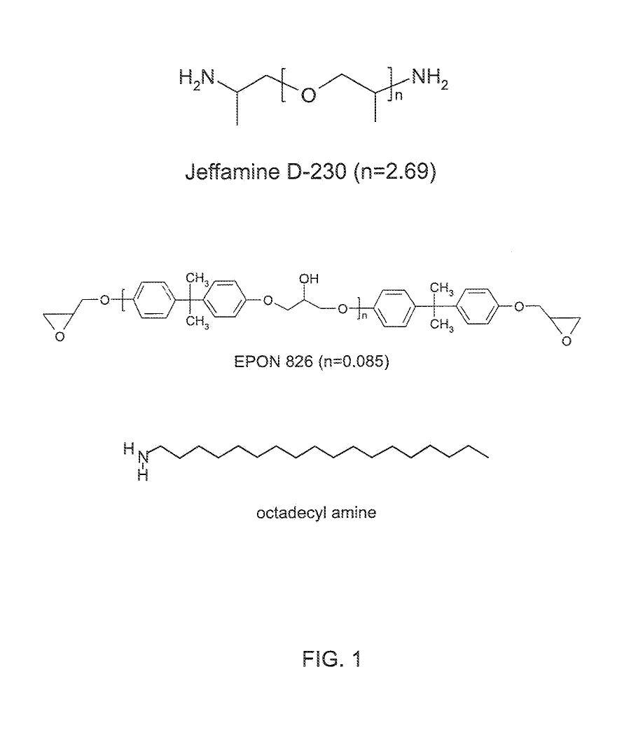

FIG. 1 illustrates the chemical structures of Jeffamine D-230, EPON 826, and an octadecyl amine.

In one embodiment, the shape memory polymer layer may be in the shape of a rectangular, circular, or square pad having a curved structure. The curved structure may be a result of the curing process or the curved structure may also be created by specifically designed molds.

Another embodiment of the invention may include a method comprising heating a single layer shape memory polymer which functions as a dry adhesive having a rigid curved structure at room temperature and applying a load to the shape memory polymer when it is heated above the glass transition temperature of the shape memory polymer layer and cooled down under the load so that the shape memory polymer adheres to an underlying substrate. The adhered shape memory polymer may have a pulp off force greater than 100 N/cm² on a substrate. The method may also include thereafter detaching the shape memory polymer comprising heating the shape memory polymer to a temperature above the glass transition temperature of the shape memory polymer layer to cause the shape memory polymer to return to a rigid curved structure.

One embodiment of the invention may include a product comprising a shape memory polymer which functions as a dry adhesive with a pull-off strength of up to 2000 N/cm² from a substrate. Various substrates may be used to achieve a pull-off strength of up to 2000 N/cm² from a substrate.

One embodiment of the invention may include a method comprising providing a shape memory polymer which functions as a dry adhesive, placing the shape memory polymer on a surface, heating the shape memory polymer to a temperature sufficient to create adhesive characteristics on the surface of the shape memory polymer, preloading the shape memory polymer with the force so that the shape memory polymer adheres to the surface and has a pull-off strength up to 2000 N/cm² from a substrate, and peeling off the shape memory polymer using a peel-off force of 1 N/cm or less from the same substrate.

Another embodiment of the invention may include a method comprising providing a shape memory polymer which functions as a dry adhesive, placing the shape memory polymer on a surface, heating the shape memory polymer to a temperature sufficient to create adhesive characteristics on the surface of the shape memory polymer, preloading the shape memory polymer with the force so that the shape memory polymer adheres to the surface and has a pull-off strength up to 2000 N/cm² from a substrate, and peeling off the shape memory polymer using a peel-off force of 1 N/cm or less from the same substrate, and repeating the attaching and peeling off steps more than six times.

Another embodiment may include a method of measuring the pull-off force to test the thermo-reversibility of the adhesion of the shape memory polymer. A bonded sample may be heated with no load to a temperature higher than the T_{g} of the shape memory polymer. After the heating, the shape memory property may return to its original sample shape. The sample, after cooling down to ambient temperature under no load, may be submitted to an adhesion test. Overall, the shape memory polymer determines both the adhesive strength and thermo-reversibility of the shape memory polymer which functions as a dry adhesive.

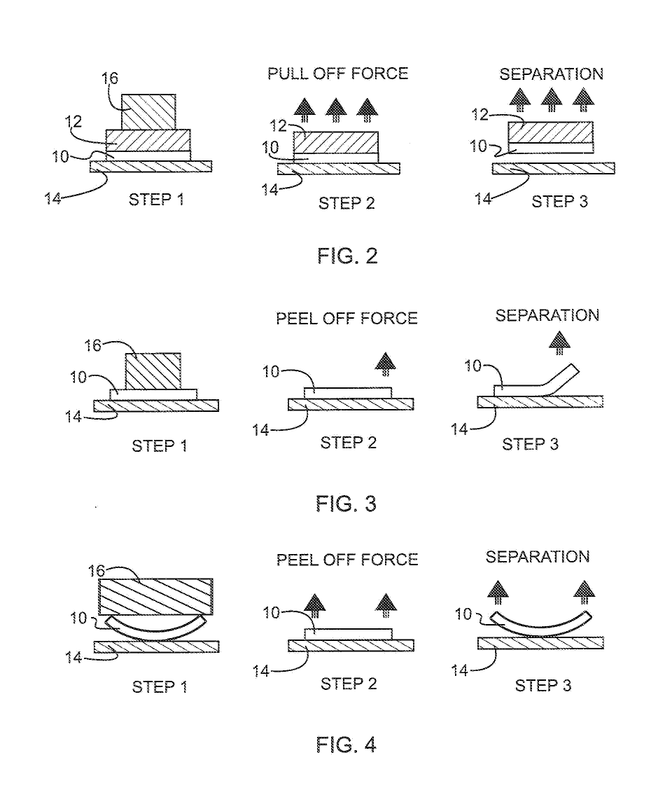

FIG. 2 illustrates an embodiment of a method of measuring the pull-off force of a shape memory polymer with a rigid backing. In STEP 1 of FIG. 2, a shape memory polymer which functions as a dry adhesive layer 10 may be affixed to a rigid backing 12. Utilizing the shape memory polymer which functions as a dry adhesive layer 10 with a rigid backing 12 may include providing a shape memory polymer which functions as a dry adhesive layer 10, placing the shape memory polymer which functions as a dry adhesive layer 10 on a substrate 14, heating the shape memory polymer which functions as a dry adhesive layer 10 to a temperature sufficient to create adhesive characteristics on the surface of the shape memory polymer, preloading the shape memory polymer which functions as a dry adhesive layer 10 and rigid backing 12 with a force 16 so that the shape memory polymer which functions as a dry adhesive layer 10 adheres to the substrate 14, and pulling off the shape memory polymer which functions as a dry adhesive layer 10 and rigid backing 12 from the substrate 14. The shape memory polymer which functions as a dry adhesive 10 may be separated from a substrate 14 with a pull-off force normal to the substrate 14. The maximum pull-off force at the point of separation may be measured by a load cell located between the shape memory polymer which functions as a dry adhesive layer 10 and the applied load 16. In one embodiment, this maximum pull-off strength may be about 60 N/cm². Unless otherwise noted, the pull-off strength may be calculated by the maximum separation force divided by the shape memory polymer surface area.

An embodiment of a method of utilizing a reversible shape memory polymer adhesive is depicted in FIG. 3. Utilizing the reversible shape memory polymer adhesive may comprise providing a shape memory polymer which functions as a dry adhesive layer 10, placing the shape memory polymer which functions as a dry adhesive layer 10 on a substrate 14, heating the shape memory polymer which functions as a dry adhesive layer 10 to a temperature sufficient to create adhesive characteristics on the surface of the shape memory polymer, preloading the shape memory polymer with a force 16 so that the shape memory polymer which functions as a dry adhesive layer 10 adheres to the substrate 14, and peeling off the shape memory polymer which functions as a dry adhesive layer 10 using a peel-off force of 1 N/cm or less from the same substrate 14.

Another embodiment of the invention is depicted in FIG. 4. A shape memory polymer adhesive which functions as a reversible adhesive 10 having a curved structure may be provided having a single adhesion layer consisting of only a shape memory polymer. By heating the single layer of shape memory polymer to a temperature at or higher than the glass transition temperature (T_{g}) of the reversible shape memory polymer adhesive 10, and applying a load 16 to the reversible shape memory polymer adhesive 10 while cooling to a temperature below the T_{g} of the shape memory polymer, the reversible shape memory polymer adhesive 10 may form an adhesive bond with a substrate 14. The bond may be released by heating the reversible shape memory polymer adhesive structure 10 to a temperature above the T_{g} of the shape memory polymer to restore the curved structure. The curved structure may be a result of the curing process of the shape memory polymer or it may be intentionally designed as such. The curved structure may facilitate a peel-off release of adhesion from the substrate.

According to an additional embodiment of the invention, a curved structure may be provided consisting of a layer of shape memory polymer which functions as a dry adhesive. By heating to a temperature higher than the glass transition temperature (T_{g}) of the shape memory polymer, and imposing a load while cooling to a temperature below the T_{g} of the shape memory polymer, the single layer structure may form a strong adhesive bond with a stainless steel substrate with a pull-off force of about 60 N/cm². The strong bond may be automatically released by heating the single layer structure to a temperature above the T_{g} of the shape memory polymer to restore the curvature.

For a shape memory polymer which functions as a reversible dry adhesive, a minimum preload may be required to achieve maximum contact between the shape memory polymer and a substrate, and therefore to achieve a maximum pull-off force.

One embodiment may provide a shape memory polymer which exhibits adhesive surface properties when heated above its glass transition temperature. The shape memory polymer may allow the single layer structure to deform and adapt to the profile of a counter surface upon heating. The shape memory polymer layer may further allow the deformed shape to be maintained after cooling. As a result, a macroscopically near perfect contact with the counter surface may be achieved, which may lead to the pull-off strength of up to 2000 N/cm² measured against a substrate. The SMP layer may not only be responsible for maximizing the surface contact but also the intrinsic adhesion to a substrate.

The adhesion reversal for the shape memory polymer which functions as a dry adhesive may be accomplished via heating. In one embodiment, the shape recovery of the shape memory polymer may occur upon heating despite the large pull-off strength measured between the shape memory polymer and a substrate due to a curved structure of the shape memory polymer. During the shape recovery process to return to an original curvature, the interfacial separation may start from the edge and gradually propagated to the center of the shape memory polymer layer. In a way, this is a peeling process or more precisely a self-peeling process. In this case, neither the large pull-off strength nor the magnitude of the recovery force of the SMP is relevant. Indeed, since the SMP may be soft at a temperature above its T_{g}, it may naturally allow the separation to occur in a peel-off mode.

The thermal reversibility of the adhesion for the shape memory polymer has important implications. A natural gecko controls its adhesion and the reversal process through its mechanical toe actions. A synthetic gecko adhesive at its best mimics only a gecko footpad, not the mechanical toe actions. For a synthetic gecko adhesive, when good adhesion is needed, accidental peeling should be avoided in which case a rigid backing layer may be desirable in principle. The rigid backing layer, however, would not allow peeling actions needed for the adhesion reversal/detachment. Unless a mechanical device is introduced to mimic mechanical gecko toe actions, the above paradox is difficult to avoid.

In another embodiment, a shape memory polymer which functions as an adhesive may be rigid below its glass transition and the rigidity may inhibit unwanted peeling to ensure good adhesion. The shape memory polymer may also become flexible at temperatures above its T_{g}, allowing peeling for adhesion reversal. Even when the shape memory polymer is cooled down to a temperature below its T_{g} after its shape recovery, the curvature may result in a 10 times drop in the pull-off strength. Thus, the controllability of the shape memory polymer adhesion may be controlled two-fold: 1) the thermal transition of the shape memory polymer from being rigid to flexible turns the ability to peel on and off, in this case, the curvature is not required; and 2) the shape recovery ability and the original curved structure may create a self-peeling mechanism to control the contact area, thus the adhesion. A naturally curved shape memory polymer may allow the second controlling mechanism to occur. Curvatures created by purposeful mold design may have the same effect. This general approach of using a shape memory polymer to control the adhesion and adhesion reversal may be applied to effectively replicate gecko toe adhesion. The adhesion reversal triggering temperature may be adjustable based on the T_{g} of the shape memory polymer selected.

The following examples of shape memory polymers are for illustrative purposes only and are not meant to limit the invention in any way.

In various embodiments, the components of a shape memory polymer may include a rigid epoxy and a flexible epoxy. The range of possible crosslinking chemistries which may be used to achieve shape memory polymer may include alpha, omega-diaminoalkanes, anhydride, or catalytic (as in imidazole type) crosslinking reactions. There are many different ways to achieve the appropriate relationships between the molecular properties. For example, the shape memory polymers may include a rigid epoxy, an epoxy extender, and a crosslinking agent; or a rigid epoxy, a flexible crosslinking agent, and a flexible epoxy; or a rigid epoxy, a rigid crosslinking agent, and a flexible epoxy; or a rigid epoxy, a flexible epoxy, and a catalytic curing agent; or a rigid epoxy, a crosslinking agent, and a diluent; or a flexible epoxy, a crosslinking agent, and a diluent; or a rigid epoxy and a flexible crosslinking agent; or a flexible epoxy and a catalytic curing agent; or a flexible epoxy and a crosslinking agent; and wherein the rigid epoxy is an aromatic epoxy having at least two epoxide groups, the flexible epoxy is an aliphatic epoxy having at least two epoxide groups, the epoxy extender has one epoxide group, and the crosslinking agent is one of a multi-amine, an organic multi-carboxylic acid, or an anhydride, and the diluent is a monoamine or a mono-carboxylic acid. In various embodiments, the catalytic curing agent (or catalytic cure) may promote epoxy-to-epoxy or epoxy-to-hydroxyl reactions. The catalytic curing agent may include, but is not limited to, tertiary amines, amine salts, boron trifluoride complexes, or amine borates. The components of the shape memory polymer may be present in an amount sufficient to provide, upon curing of the composition, a shape memory polymer having a glass transition temperature of −90° C. to 200° C. and having a pull-off strength of up to 2000 N/cm² from a substrate. In one embodiment, the components of the shape memory polymer composition may be present in an amount sufficient to provide, upon curing of the composition, a shape memory polymer having a change in storage modulus of 2 to 3 orders of magnitude before and after its glass transition. In one embodiment, the components of the shape memory polymer composition may be present in an amount sufficient to provide a shape memory polymer with adhesive material properties when heated above its glass transition temperature.

The above description of embodiments of the invention is merely exemplary in nature and, thus, variations thereof are not to be regarded as a departure from the spirit and scope of the invention.

What is claimed is:

1. A product comprising:
a shape memory polymer which functions as a reversible dry adhesive comprising a shape memory polymer composition which exhibits adhesive properties when heated to or above its glass transition temperature;
the shape memory polymer which functions as a reversible dry adhesive further comprising a curved structure sufficient to facilitate a peel-off release of adhesion from a substrate when the shape memory polymer which functions as a reversible dry adhesive is heated to or above its glass transition temperature; and
wherein the shape memory polymer which functions as a reversible dry adhesive has a pull-off strength greater than a peel-off strength of the reversible shape memory polymer which functions as a dry adhesive.

2. The product of claim 1:
wherein the glass transition temperature ranges from about 30° Celsius to about 300° Celsius.

3. The product of claim 1:
wherein the composition further comprises a mixture of EPON 826 with Jeffamin D-230 and decylamine at a mole ratio of 20:0.5:19.

4. The product of claim 1:
wherein the composition further comprises a rigid epoxy or a flexible epoxy and a crosslinking agent or a catalytic curing agent.

5. The product of claim 1:
wherein the shape memory polymer which functions as a reversible dry adhesive has a pull-off force of up to 2000 N/cm² from a substrate.

6. The product of claim 1:
wherein the shape memory polymer which functions as a reversible dry adhesive may be in the shape of a rectangular, circular, or square pad having a curved structure.

7. The product of claim 1:
wherein the shape memory polymer which functions as a reversible dry adhesive may be rigid below its glass transition temperature.

8. The product of claim 1:
wherein the shape memory polymer layer may have a curved structure below its glass transition temperature and unaffected by a load.

9. A method comprising:
providing a single layer shape memory polymer having a curved structure at room temperature;
heating the single layer shape memory polymer above its glass transition temperature so that the shape memory polymer has adhesive properties;
providing a substrate, placing the shape memory polymer on the substrate;
applying a load to the single layer shape memory polymer; and
cooling the single layer shape memory polymer down under the applied load so that the single layer shape memory polymer adheres to the substrate.

10. The method of claim 9 further comprising:
heating the single layer shape memory polymer above its glass transition temperature a second time to cause the shape memory polymer to return to a curved structure and subsequently un-adhere to the substrate.

11. The method of claim 9:
wherein the shape memory polymer which functions as a reversible dry adhesive has a pull-off force of up to 2000 N/cm² from a substrate.

12. The method of claim 9:
wherein the shape memory polymer which functions as a reversible dry adhesive may be rigid below its glass transition temperature.

13. A method comprising:
preparing a shape memory polymer which functions as a reversible dry adhesive comprising a shape memory polymer composition which is submitted to a heated curing process and exhibits adhesive properties when heated above its glass transition temperature;
the shape memory polymer which functions as a reversible dry adhesive further comprising a curved structure sufficient to facilitate a peel-off release of adhesion from a substrate when the shape memory polymer which functions as a reversible dry adhesive is heated to or above its glass transition temperature; and
the shape memory polymer which functions as a reversible dry adhesive has a pull-off strength greater than a peel-off strength by at least a multiple of ten.

14. The method of claim 13:
wherein the composition of the shape memory polymer which functions as a reversible dry adhesive comprises a mixture of EPON 826 with Jeffamin D-230 and decylamine at a mole ratio of 20:0.5:19; and
wherein the heated curing process comprises pouring the mixture into a mold and curing the mixture in an oven at 100° C. for one hour and may include additionally curing the mixture in an oven at 130° C. for one hour.

15. The method of claim 13:
wherein the shape memory polymer which functions as a reversible dry adhesive may be rigid below its glass transition temperature.
